(19) United States
(12) Patent Application Publication
(10) Pub. No.: US 2017/0355221 A1
(43) Pub. Date: Dec. 14, 2017

(54) PAINT CLEANING TOOL

(71) Applicant: Joanne Kenney, Ashburnham, MA (US)

(72) Inventor: Joanne Kenney, Ashburnham, MA (US)

(21) Appl. No.: 15/181,567

(22) Filed: Jun. 14, 2016

(51) Int. Cl. B44D 3/00; B08B 1/00; B05C 17/02

(52) U.S. Cl. CPC B44D 3/006; B05C 17/0245; B08B 1/001

(57) ABSTRACT

A cylindrical conical cleaning tool that includes: an opening; a top edge with a first diameter; and a bottom edge with a second diameter, wherein the second diameter is smaller than the first diameter and said second diameter adapted to fit along an outer surface of a paint roller. The cylindrical conical cleaning tool further includes an inner surface, where the inner surface is adapted to channel moisture away from the paint roller. In another embodiment, the cylindrical conical cleaning tool includes a lip at the top edge, wherein the lip is adapted for gripping purposes.

### BACKGROUND OF THE INVENTION

### Field of Invention

The present invention relates to a cleaning tool that is used to clean paint rollers.

### Description of Related Art

Painting is a common task paint is applied to a wall or other surface typically through the use of a brush or paint rollers. Depending on the surface and timing considerations using paint rollers can be a bit more effective in covering a larger surface. Paint rollers are usually hand-held and have a napped surface that holds paint for application onto a surface. Many times painters must use several rollers doing a paint job. Further many painters in order to save money re-use the paint rollers by removing the paint residue from the roller after using a particular color. However, the cleaning time for cleaning paint rollers can be quite time-consuming. Due to the repeated use the paint residue can be quite embedded in the paint roller. As a result, thoroughly cleaning the rollers could take a considerable amount of time. As an alternative, painters may be forced to purchase multiple rollers with various colors then simply re-use that roller for repeated use with the same color. Therefore, it would be effective to have a device that may assist in the cleaning of a paint roller and in particular to efficiently clean a paint roller.

### SUMMARY OF THE INVENTION

The present invention relates a cylindrical conical cleaning tool that includes: an opening; a top edge with a first diameter; and a bottom edge with a second diameter, wherein the second diameter is smaller than the first diameter and said second diameter adapted to fit along an outer surface of a paint roller. The cylindrical conical cleaning tool further includes an inner surface, where the inner surface is adapted to channel moisture away from the paint roller. In another embodiment, the cylindrical conical cleaning tool includes a lip at the top edge, wherein the lip is adapted for gripping purposes.

The present invention also includes a method of cleaning a paint roller that includes the steps of: attaching a cylindrical conical tool to a paint roller at a first end, wherein the tool includes a first diameter at a first edge adapted to fit directly onto the surface and a second diameter at a second edge adapted for gripping purposes; moving the cylindrical conical tool along the surface of the paint roller; and drawing moisture from the paint roller while performing the step of moving.

### BRIEF DESCRIPTION OF DRAWINGS

FIG. 1 depicts use of a paint roller cleaning tool over a paint roller.

FIG. 2 depicts a top view of the paint roller cleaning tool in accordance with the present invention.

### DETAILED DESCRIPTION

The present invention is a cylindrical conical shaped tool that is used to dry and remove paint residue from a paint roller. The tool essentially slides over the paint roller providing a tight fit for movement over the surface of the roller. This tight fit helps to squeeze paint residue and moisture from the roller so that the roller may dry quickly for use with another color of paint.

The tool is cylindrical with a first opening with a first diameter and a second opening with a second diameter. The first diameter is smaller than the second diameter therefore providing a tight squeeze around the roller. At the second diameter, a lip extends outward from the perimeter to provide for a gripping surface for the user. During use, a user inserts a paint roller into the cleaning tool and pulls the cleaning tool over the surface of the roller. The tool inherently helps to remove fluids and deep paint residue by providing a squeezing effect over the surface. As a result, the cleaning tool rings out the water and helps to speed up the drying time needed for a paint roller after cleaning.

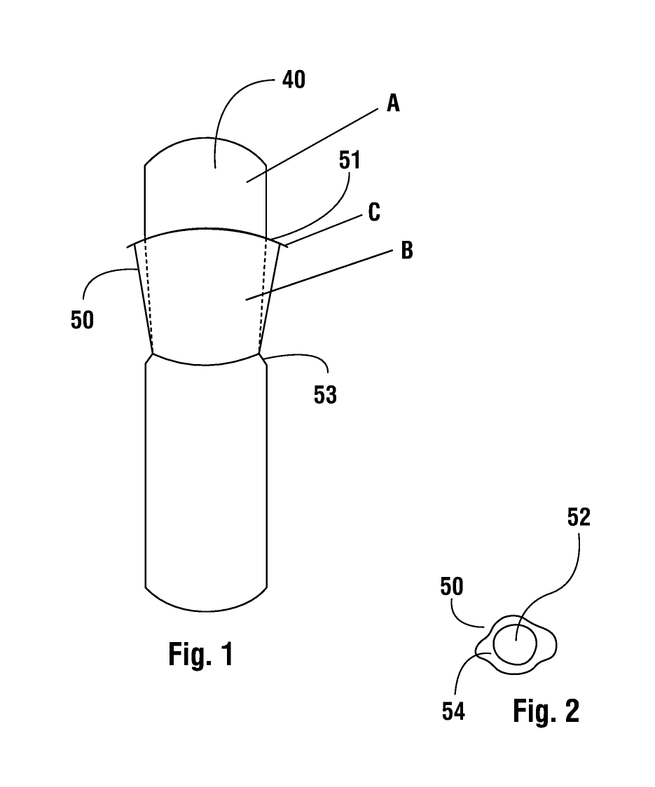

In reference to FIG. 1, a Cleaning Tool 50 in accordance with the present invention is shown around a Paint Roller 40. As stated this cleaning tool 50 has a Top Edge 51 and a Bottom

Edge 53. The top edge 51 has a first diameter, which is wider than the Paint Roller 40. The diameter of the Bottom Edge 53 is tight providing a tight squeeze over the surface of the roller as a user moves the tool over the length of Roller 40.

FIG. 2 depicts a top view of the Cleaning Tool 50. This top view shows an Opening 52 in a Lip 54 at the Top Edge 51 of the Cleaning Tool 50. This Top Lip 54 provides gripping surface for the user to maneuver the tool over the length of the paint roller. Use of the Cleaning Tool 50 provides an efficient and effective way to quickly clean a paint roller. The instant invention has been shown and described in what it considers to be the most practical and preferred embodiments. It is recognized, however, that departures may be made there from within the scope of the invention and that obvious modifications will occur to a person skilled in the art.

What is claimed is:

1. A cylindrical conical cleaning tool comprising:
a. an opening;
b. a top edge with a first diameter; and
c. a bottom edge with a second diameter, wherein the second diameter is smaller than the first diameter and said second diameter adapted to fit along an outer surface of a paint roller.

2. The cylindrical conical cleaning tool according to claim 1, further including an inner surface, where the inner surface is adapted to channel moisture away from the paint roller.

3. The cylindrical conical cleaning tool according to claim 1, further including a lip at the top edge, wherein the lip is adapted for gripping purposes.

4. A method of cleaning a paint roller comprising the steps of:
a. attaching a cylindrical conical tool to a paint roller at a first end, wherein the tool includes a first diameter at a first edge adapted to fit directly onto the surface and a second diameter at a second edge adapted for gripping purposes;
b. moving the cylindrical conical tool along the surface of the paint roller; and
c. drawing moisture from the paint roller while performing the step of moving.
